(19) United States
(12) Patent Application Publication
(10) Pub. No.: US 2023/0411923 A1
(43) Pub. Date: Dec. 21, 2023

(54) Additive Manufacturing System Using Homogenizers and Shaped Amplifiers

(71) Applicant: Seurat Technologies, Inc., Wilmington, MA (US)

(72) Inventors: Andrew J. Bayramian, Marblehead, MA (US); James A. DeMuth, Woburn, MA (US); Selim Elhadj, Lexington, MA (US)

(21) Appl. No.: 18/337,948

(22) Filed: Jun. 20, 2023

Related U.S. Application Data
(60) Provisional application No. 63/354,075, filed on Jun. 21, 2022.

(51) Int. Cl. H01S 3/094; H01S 3/06; H01S 3/23; B33Y 30/00; B29C 64/268; B22F 12/41

(52) U.S. Cl. CPC H01S 3/094049; H01S 3/0606; H01S 3/2333; H01S 3/2316; B33Y 30/00; B29C 64/268; B22F 12/41; H01S 3/094084

(57) ABSTRACT

A method of additive manufacture utilizing a uniform laser beam is disclosed. A seed laser projects a laser beam having a first laser beam shape. At least one pre-amplifier is positioned to receive the laser beam and amplify laser beam power. A homogenizer is positioned to receive the amplified laser beam from the at least one pre-amplifier and alter the first laser beam shape into a second laser beam shape. A main amplifier is positioned to receive the amplified laser beam having the second laser beam shape from the homogenizer and amplify laser beam power.

### RELATED APPLICATION

The present disclosure is part of a non-provisional patent application claiming the priority benefit of U.S. Patent Application No. 63/354,075, filed on Jun. 21, 2022, which is incorporated by reference in its entirety.

### TECHNICAL FIELD

The present disclosure generally relates to additive manufacturing and, more particularly, to high efficiency laser systems supporting homogenizers positionable between pre-amplifiers and non-cylindrical cross section shaped amplifiers.

### BACKGROUND

Traditional component machining often relies on removal of material by drilling, cutting, or grinding to form a part. In contrast, additive manufacturing, also referred to as three-dimensional (3D) printing, typically involves sequential layer-by-layer addition of material to build a part.

High power lasers suitable for two-dimensional additive printing are expected to meet stringent requirements in terms of energy stability, spatial beam uniformity, temporal control, and spectral control. While there are difficulties with each of these requirements, perhaps the more difficult to maintain is the spatial uniformity as coherence combined with imperfections in optics, and surface reflections work to compromise output beam uniformity.

One way of improving beam uniformity involves destroying the wavefront and/or coherence of the beam by homogenization. Unfortunately, this can result in significant power losses (as much as 20%), increase system operation costs, and reduce system performance.

High efficiency laser systems suitable for enhancing efficiency during two-dimensional additive printing are needed. Such systems should have extreme beam profile uniformity and ideally support beam shapes suitable for tiling or stitching useful for two-dimensional additive printing.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1A illustrates a laser system 100A for an additive manufacturing system with a homogenizer positioned between pre-amplifiers and main amplifiers;

FIG. 1B illustrates a laser system 100B for an additive manufacturing system with a homogenizer positioned between pre-amplifiers and slab type main amplifiers;

FIG. 1C illustrates a laser system for an additive manufacturing system with a homogenizer positioned between pre-amplifiers and main amplifiers and a patterning device positioned a relay plane;

FIG. 2A illustrates a non-cylindrical, square cross section shaped amplifier rod with bonded endcaps;

FIG. 2B illustrates a non-cylindrical, hexagonal cross section shaped amplifier rod with bonded endcaps;

FIG. 3A illustrates in perspective side view an interface plate for mating non-cylindrical amplifiers to cylindrical based o-ring sealed components;

FIG. 3B illustrates in front view the interface plate of FIG. 3A for mating non-cylindrical amplifiers with a standard cylindrical o-ring interface; and

FIG. 4 illustrates an additive manufacturing system with shaped amplifiers.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

In one embodiment, providing a laser systems suitable for enhancing efficiency during two-dimensional additive printing or other applications requires improving overall efficiency of the amplifier. If the laser system contains an amplifier, low efficiency can be overcome by placing the homogenizer earlier in the amplifier system. For example, a typical master oscillator power amplifier (MOPA) system is the backbone of many high energy and/or high power laser architectures. In a MOPA the laser beam starts as a low power or energy “seed” that is amplified in successive stages to higher and higher power/energy. The amplification typically spans many orders of magnitude with changes in energy or power by factors of millions to billions. As such the stored energy or power in the smaller amplifiers is a relatively small fraction of the stored energy or power of the larger amplifiers and an efficiency hit of 10-20% at this stage is largely erased by the larger amplifier systems which run in saturation to achieve optimum efficiency. For example, a MOPA system with one or more large final amplifiers that deliver 10 J of output can be seeded by a 100 mJ input signal. If this input signal experiences a loss of 20%, it would be 80 mJ, in effect requiring 20% more power on the 100 mJ amplifier to regain 100 mJ. However, since 20 mJ is recovered to maintain 10 J of output the effective efficiency hit is only 0.02/10=0.2% to the overall efficiency, erasing the efficiency hit of the input signal loss. To maximize efficiencies, the final amplifiers are heavily extracted which typically involves multipass amplification to ensure all parts of the amplifier see a high signal.

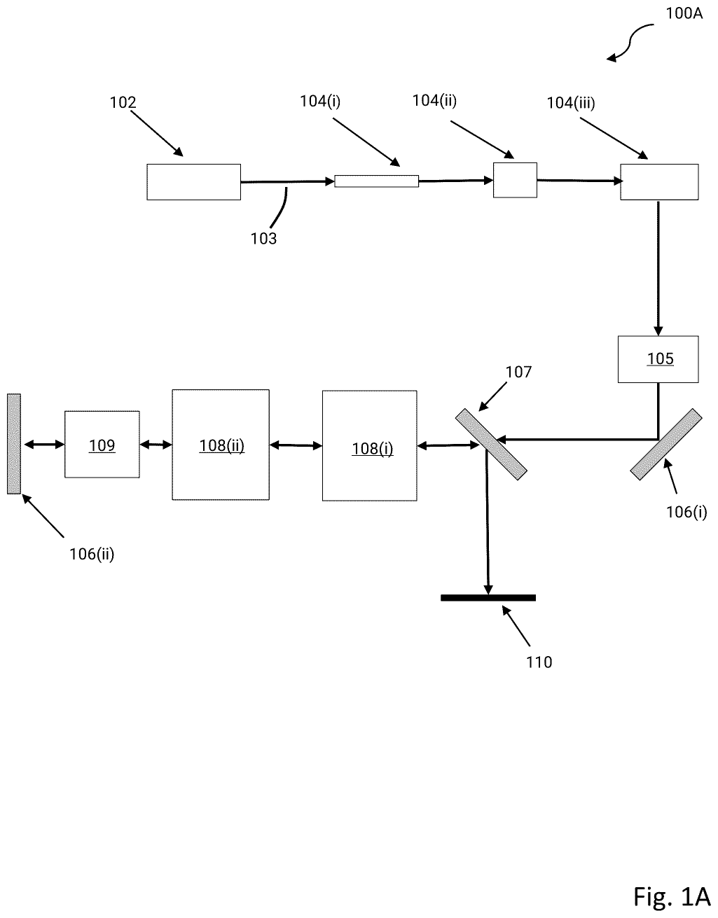

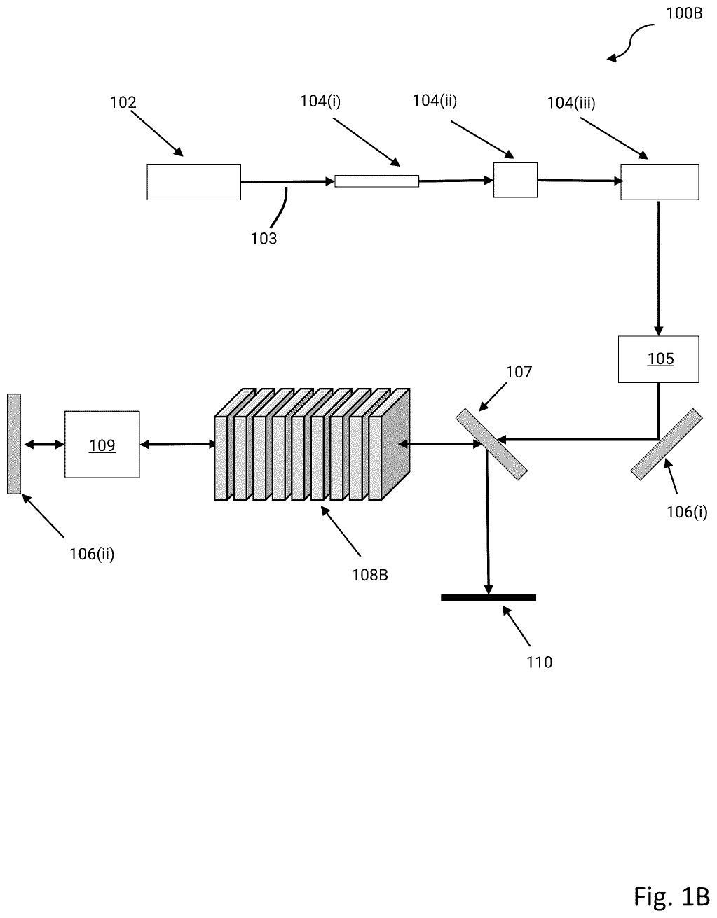

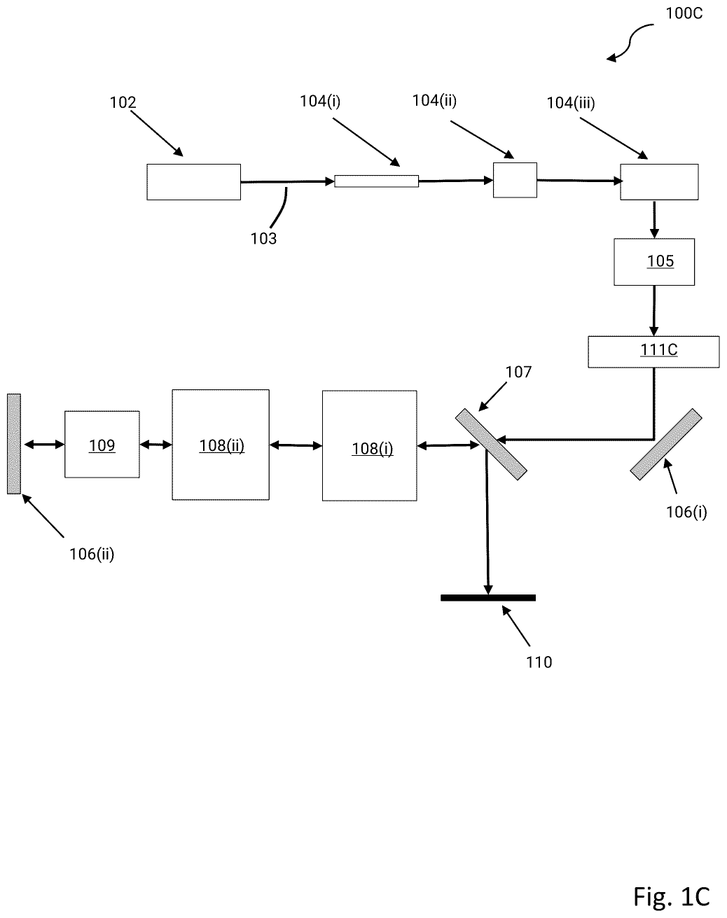

FIG. 1A illustrates a laser system 100A for an additive manufacturing system with a homogenizer positioned between pre-amplifiers and main amplifiers. As illustrated, a seed laser source 102 propagates a laser beam 103 to one or more preamplifiers (e.g. pre-amplifier 104(i), pre-amplifier 104(ii), or pre-amplifier 104(iii)). The laser beam 103 enters a homogenizer system 105 that has a shaped homogenized image output projected to amplifier 108(i) and amplifier 108(ii) after reflection from mirror 106(i) and passing through polarizer 107. A faraday rotator 109 and mirror 106(ii) are used as a passive switch to achieve double pass amplification of the amplifiers 108(i) and 108(ii). The output beam hits the polarizer 107, is deflected out of the amplifiers 108(i) and 108(ii) and is imaged to a target plane 110.

FIG. 1B illustrates a laser system 100B for an additive manufacturing system with a homogenizer positioned between pre-amplifiers and slab type main amplifiers. As illustrated, a seed laser source 102 propagates a laser beam 103 to one or more preamplifiers (e.g. pre-amplifier 104(i), pre-amplifier 104(ii), or pre-amplifier 104(iii)). The laser beam 103 enters a homogenizer system 105 that has a shaped homogenized image output projected to slab amplifier 108B after reflection from mirror 106(i) and passing through polarizer 107. A faraday rotator 109 and mirror 106(ii) are used as a passive switch to achieve double pass amplification of the slab amplifier 108B. The output beam hits the polarizer 107, is deflected out of the slab amplifier 108B and is imaged to a target plane 110.

In some embodiments, slab amplifiers can include Brewster angled slabs such as used in flashlamp pumped systems, total internal reflection slab amplifiers, gas cooled amplifiers, and thin disk amplifiers. All of these amplifiers use a large face of the slab for efficient heat removal needed for high power operation. Some of them, such as thin disk and gas cooled amplifiers have pump radiation, extraction radiation, and a thermal gradient all in the same direction. This alignment enables massive power and energy scaling with minimum beam distortion. Another advantage of these amplifiers is that the shape of these slabs or thin disks be selected as needed. A slab can be square, rectangle, hexagonal, round, or other desired shape.

In those embodiments of a slab amplifier where the laser system has multiple outputs, propagating a patterned image can involve having the same pattern going to all beam lines. This option would be the so-called replication method and would be useful for jobs that are repetitive or in the case of patterned printing where the job is many of the same object and parallel printing is possible. This method can be achieved by positioning a patterning device (not shown) before the amplification pathways splits. Alternatively, a common image can be divided into n portions where n is an integer number greater than 1 and those different patterns sent to each of the beam lines. In this case the patterning device can be located after the beams split.

FIG. 1C illustrates a laser system 100C for an additive manufacturing system with a homogenizer positioned between pre-amplifiers and main amplifiers and a patterning device positioned at the relay plane. As illustrated, a seed laser source 102 propagates a laser beam 103 to one or more preamplifiers (e.g. pre-amplifier 104(i), pre-amplifier 104(ii), or pre-amplifier 104(iii)). The laser beam 103 enters a homogenizer system 105 that has a shaped homogenized image output projected to a patterning device 111C such as an optically addressed light valve (OALV), DLP, or other suitable patterning devices. The patterned output is sent to amplifiers 108(i) and 108(ii) after reflection from mirror 106(i) and passing through polarizer 107. A faraday rotator 109 and mirror 106(ii) are used as a passive switch to achieve double pass amplification of the amplifiers (e.g. amplifier 108(i) and amplifier 108(ii)). The output beam hits the polarizer 107, is deflected out of the amplifiers 108(i) and 108(ii) and is imaged to a target plane 110.

In some embodiments, the seed laser 102 can include multiple laser sources used in combination. The seed laser 102 can include lasers such as: Gas Lasers, Chemical Lasers, Dye Lasers, Metal Vapor Lasers, Solid State Lasers (e.g. fiber), Semiconductor (e.g. diode) Lasers, Free electron laser, Gas dynamic laser, “Nickel-like” Samarium laser, Raman laser, or Nuclear pumped laser.

A Gas Laser can include lasers such as a Helium-neon laser, Argon laser, Krypton laser, Xenon ion laser, Nitrogen laser, Carbon dioxide laser, Carbon monoxide laser or Excimer laser.

A Chemical laser can include lasers such as a Hydrogen fluoride laser, Deuterium fluoride laser, COIL (Chemical oxygen-iodine laser), or Agil (All gas-phase iodine laser).

A Metal Vapor Laser can include lasers such as a Helium-cadmium (HeCd) metal-vapor laser, Helium-mercury (HeHg) metal-vapor laser, Helium-selenium (HeSe) metal-vapor laser, Helium-silver (HeAg) metal-vapor laser, Strontium Vapor Laser, Neon-copper (NeCu) metal-vapor laser, Copper vapor laser, Gold vapor laser, or Manganese (Mn/MnCl2) vapor laser. Rubidium or other alkali metal vapor lasers can also be used. A Solid State Laser can include lasers such as a Ruby laser, Nd:YAG laser, NdCrYAG laser, Er:YAG laser, Neodymium YLF (Nd:YLF) solid-state laser, Neodymium doped Yttrium orthovanadate(Nd:YVO4) laser, Neodymium doped yttrium calcium oxoborateNd:YCa4O(BO3)3 or simply Nd:YCOB, Neodymium glass(Nd:Glass) laser, Titanium sapphire(Ti:sapphire) laser, Thulium YAG (Tm:YAG) laser, Ytterbium YAG (Yb:YAG) laser, Ytterbium:2O3 (glass or ceramics) laser, Ytterbium doped glass laser (rod, plate/chip, and fiber), Holmium YAG (Ho:YAG) laser, Chromium ZnSe (Cr:ZnSe) laser, Cerium doped lithium strontium (or calcium)aluminum fluoride(Ce:LiSAF, Ce:LiCaF), Promethium 147 doped phosphate glass(147Pm+3:Glass) solid-state laser, Chromium doped chrysoberyl (alexandrite) laser, Erbium doped anderbium—ytterbium co-doped glass lasers, Trivalent uranium doped calcium fluoride (U:CaF2) solid-state laser, Divalent samarium doped calcium fluoride(Sm:CaF2) laser, or F-Center laser.

A Semiconductor Laser can include laser medium types such as GaN, InGaN, AlGaInP, AlGaAs, InGaAsP, GaInP, InGaAs, InGaAsO, GaInAsSb, lead salt, Vertical cavity surface emitting laser (VCSEL), Quantum cascade laser, Hybrid silicon laser, or combinations thereof.

For example, in one embodiment a single Nd:YAG q-switched laser can be used in conjunction with multiple semiconductor lasers. In another embodiment, an electron beam can be used in conjunction with an ultraviolet semiconductor laser array. In still other embodiments, a two-dimensional array of lasers can be used. In some embodiments with multiple energy sources, pre-patterning of an energy beam can be done by selectively activating and deactivating energy sources.

The laser beam can be shaped by a great variety of imaging optics to combine, focus, diverge, reflect, refract, homogenize, adjust intensity, adjust frequency, or otherwise shape and direct one or more laser beams received from a laser beam source toward the energy patterning unit. In one embodiment, multiple light beams, each having a distinct light wavelength, can be combined using wavelength selective mirrors (e.g. dichroics) or diffractive elements. In other embodiments, multiple beams can be homogenized or combined using multifaceted mirrors, microlenses, and refractive or diffractive optical elements.

Various pre-amplifier modules are used to provide high gain to the laser signal, while optical modulators and isolators can also be distributed throughout the system to reduce or avoid optical damage, improve signal contrast, and prevent damage to lower energy portions of systems. Optical modulators and isolators can include, but are not limited to Pockels cells, Faraday rotators, Faraday isolators, acousto-optic reflectors, or volume Bragg gratings. Pre-amplifier modules could be diode pumped or flash lamp pumped amplifiers and configured in single and/or multi-pass or cavity type architectures. As will be appreciated, the term pre-amplifier here is used to designate amplifiers which are not limited thermally (i.e. they are smaller) versus power amplifiers (larger). Power amplifiers will typically be positioned to be the final units in a laser system and will be the first modules susceptible to thermal damage, including but not limited to thermal fracture or excessive thermal lensing.

Pre-amplifier modules can include single pass pre-amplifiers. For more energy efficient systems, multipass pre-amplifiers can be configured to extract much of the energy from each pre-amplifier before going to the next stage. The number of pre-amplifiers needed for a particular system is defined by system requirements and the stored energy/gain available in each amplifier module. Multipass pre-amplification can be accomplished through angular multiplexing or polarization switching (e.g. using waveplates or Faraday rotators).

Alternatively, pre-amplifiers can include cavity structures with a regenerative amplifier type configuration. While such cavity structures can limit the maximum pulse length due to typical mechanical considerations (length of cavity), in some embodiments “white cell” cavities can be used. A “white cell” is a multipass cavity architecture in which a small angular deviation is added to each pass. By providing an entrance and exit pathway, such a cavity can be designed to have extremely large number of passes between entrance and exit allowing for large gain and efficient use of the amplifier. One example of a white cell would be a confocal cavity with beams injected slightly off axis and mirrors tilted such that the reflections create a ring pattern on the mirror after many passes. By adjusting the injection and mirror angles the number of passes can be changed.

As seen in FIG. 1C, patterning device 111C can include static or dynamic energy patterning elements. For example, laser beams can be blocked by masks with fixed or movable elements. To increase flexibility and ease of image patterning, pixel addressable masking, image generation, or transmission can be used. In some embodiments, the energy patterning unit includes addressable light valves, alone or in conjunction with other patterning mechanisms to provide patterning. The light valves can be transmissive, reflective, or use a combination of transmissive and reflective elements. Patterns can be dynamically modified using electrical or optical addressing. In one embodiment, a transmissive optically addressed light valve acts to rotate polarization of light passing through the valve, with optically addressed pixels forming patterns defined by a light projection source. In another embodiment, a reflective optically addressed light valve includes a write beam for modifying polarization of a read beam. In yet another embodiment, an electron patterning device receives an address pattern from an electrical or photon stimulation source and generates a patterned emission of electrons.

Amplifiers such as seen in FIGS. 1A and 1C (i.e. amplifiers 108(i) and 108(ii)) or FIG. 1B (slab amplifier 108B) can also be used to provide enough stored energy to meet system energy requirements, while supporting sufficient thermal management to enable operation at system required repetition rate whether they are diode or flashlamp pumped. Amplifiers can be configured in single and/or multi-pass or cavity type architectures. Amplifiers can include single pass amplifiers. For more energy efficient systems, multipass amplifiers can be configured to extract much of the energy from each amplifier before going to the next stage. The number of amplifiers needed for a particular system is defined by system requirements and the stored energy/gain available in each amplifier module. Multipass pre-amplification can be accomplished through angular multiplexing or polarization switching (e.g. using waveplates or Faraday rotators). Alternatively, power amplifiers can include cavity structures with a regenerative amplifier type configuration. As discussed with respect to preamplifier modules, in some embodiments white cell cavities can be used for amplification.

As will be appreciated, laser flux and energy can be scaled in this architecture by adding more pre-amplifiers and amplifiers with appropriate thermal management and optical isolation.

To further improve laser system efficiency, in some embodiments shaped amplifiers that can be matched to homogenizer beam output can be utilized. This is of particular use for applications that use squares, rectangles, hexagons, or other shapes suitable for gapless coverage of a surface.

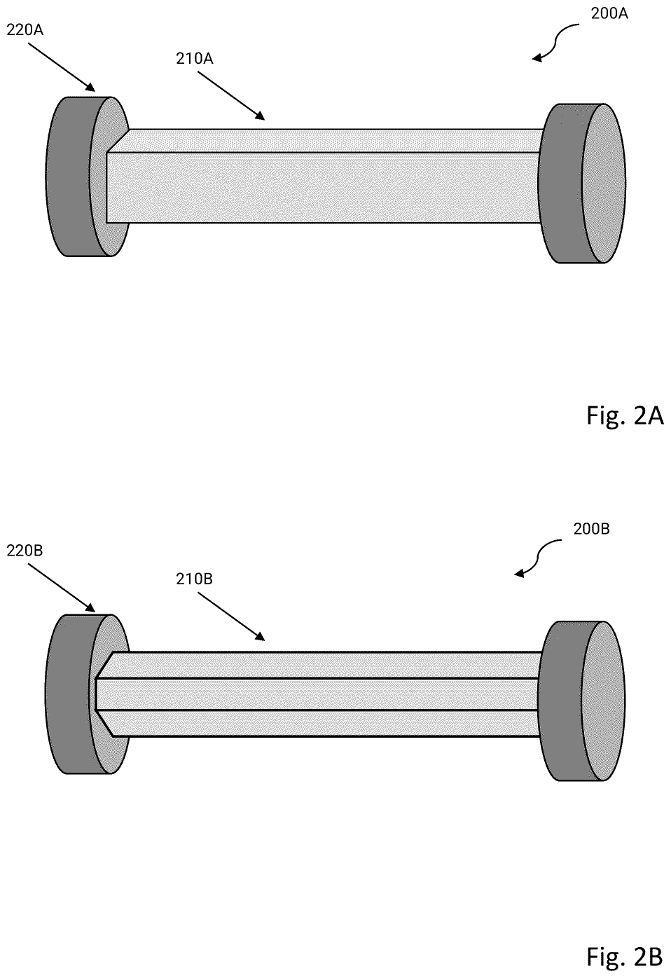

FIG. 2A illustrates a component 200A of a laser amplifier system. In this embodiment, a non-cylindrical, square cross section shaped amplifier rod 210A can be used to receive square cross section beams (not shown) from pre-amplifiers and homogenizers. To simplify mating with other laser amplifier system components, cylindrical end caps 220A can be bonded to the amplifier rod 210A.

FIG. 2B illustrates a component 200B of a laser amplifier system. In this embodiment, a non-cylindrical, square cross section shaped amplifier rod 210B can be used to receive hexagonal cross section beams (not shown) from pre-amplifiers and homogenizers. To simplify mating with other laser amplifier system components, cylindrical end caps 220B can be bonded to the amplifier rod 210B.

Thermal issues can also reduce laser amplifier system efficiency. In some embodiments, O-rings or other interface elements can be used to contact and cool amplifier rods. Unfortunately, this can be difficult when non-cylindrical amplifier rods are used. In some embodiments, cylindrical or custom shaped end parts can be formed on a single shaped rod. Alternatively, cylindrical end pieces can be bonded to the ends of a non-cylindrically shaped amplifier rod such as illustrated with respect to FIGS. 2A and 2B. These cylindrical end caps can be bonded to the non-cylindrically shaped amplifier rod using one or more of diffusion bonding (DB), chemically assisted diffusion bonding (CADB), and the use of high strength optical cements (e.g. cements conventionally used in bonded polarizers, achromats, etc.).

In another embodiment, a non-cylindrically shaped amplifier rod can include an O-ring interface fabricated surrounding the rod. In one example a round die with a hole the shape of the rod cut through the center can be used. In another example several pieces can be bonded together around the rod to create the outer O-ring interface. Since the laser beam does not propagate through this bond, the bonding material does not have to handle the full laser power and the round outer portions do not have to be optical grade. In addition these materials do not have to be expansion matched to the rod material (as would be required for the DB, CADB and even cemented applications). Examples of the round die material can include rod material, glass, ceramic, metal, and even plastics. Examples of the bonding agent can include optical cement, silicone sealant, fluorosilicone sealant, urethanes and other potting type compounds. In all cases it is preferable that the materials be white or clear to prevent or reduce coupling with radiation present in the area.

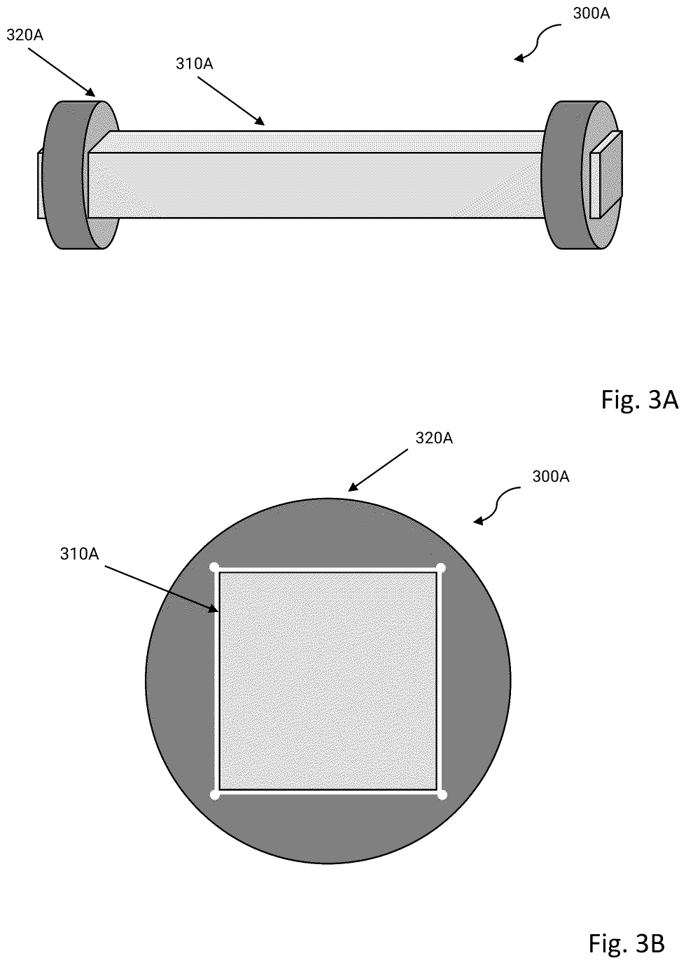

FIG. 3A illustrates in perspective side view an interface plate 300A for mating non-cylindrical amplifiers 310A with a standard cylindrical o-ring interface, while allowing for thermal transfer or cooling. In this embodiment, a non-cylindrical, square cross section amplifier rod 310A is arranged to mate with a surrounding O-ring system 320A.

FIG. 3B illustrates in front view the mating component 300A of FIG. 3A for mating non-cylindrical amplifier rod 310A with a standard cylindrical o-ring interface. As illustrated, the non-cylindrical, square cross section amplifier rod 310A is arranged to mate with a standard cylindrical o-ring interface 320A.

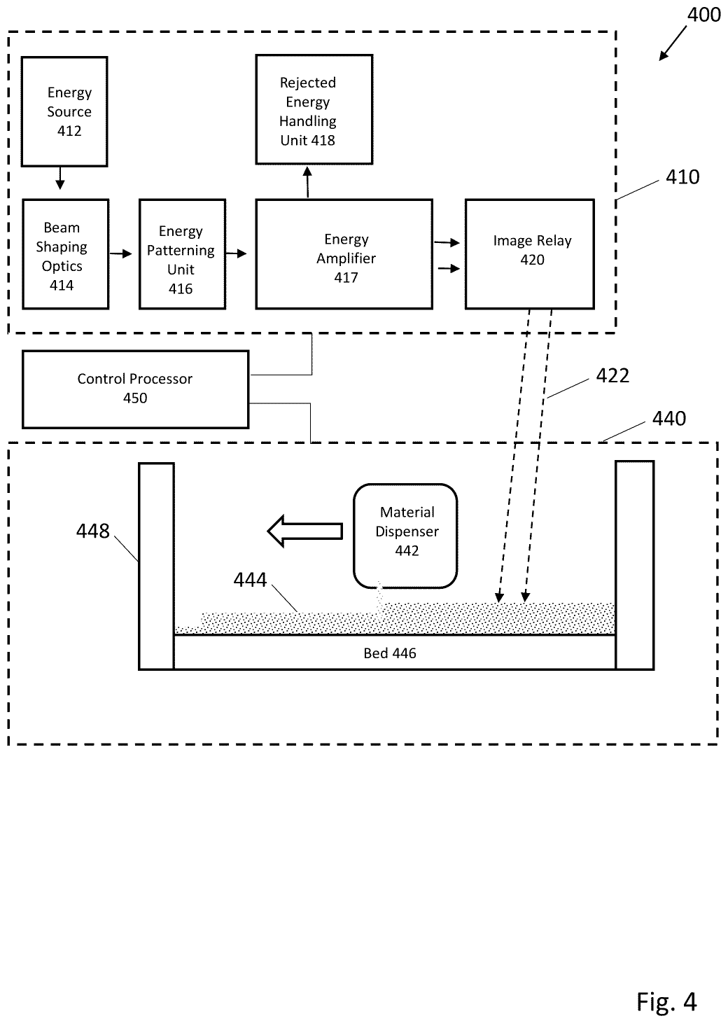

FIG. 4 illustrates an additive manufacturing system 400 suitable for use with homogenizers positioned between pre-amplifiers and shaped amplifiers. An additive manufacturing system is disclosed which has one or more energy sources, including in one embodiment, one or more laser or electron beams, positioned to emit one or more energy beams. Beam shaping optics may receive the one or more energy beams from the energy source and form or otherwise shape them a single beam having a desired cross section and uniformity. An energy patterning unit receives or generates the single beam and transfers a two-dimensional pattern to the beam and may reject the unused energy not in the pattern. An image relay receives the two-dimensional patterned beam and focuses it as a two-dimensional image to a desired location on a height fixed or movable build platform (e.g. a powder bed). In certain embodiments, some or all of any rejected energy from the energy patterning unit is reused.

In some embodiments, multiple beams from the laser array(s) are combined or shaped using a beam homogenizer. This combined beam can be directed at an energy patterning unit that includes either a transmissive or reflective pixel addressable light valve. In one embodiment, the pixel addressable light valve includes both a liquid crystal module having a polarizing element and a light projection unit providing a two-dimensional input pattern. The two-dimensional image focused by the image relay can be sequentially directed toward multiple locations on a powder bed to build a 3D structure.

As seen in FIG. 4, the additive manufacturing system 400 has an energy patterning system 410 with an energy source 412 (e.g. seed laser and pre-amplifiers) that can direct one or more continuous or intermittent laser energy beam(s) toward beam shaping optics 414 that can include a homogenizer. After homogenization and/or shaping, the laser beam is patterned by an energy patterning unit 416 and amplified by laser amplifier 417, with generally some beam energy being directed to a rejected energy handling unit 418. Patterned energy is relayed by image relay 420 toward an article processing unit 140, typically as a two-dimensional image 422 focused near a bed 446. The bed 446 (with optional walls 448) can form a chamber containing material 444 dispensed by material dispenser 442. Patterned energy, directed by the image relay 420, can melt, fuse, sinter, amalgamate, change crystal structure, influence stress patterns, or otherwise chemically or physically modify the dispensed material 444 to form structures with desired properties.

Beam shaping unit 414 can include a great variety of imaging optics to combine, focus, diverge, reflect, refract, homogenize, adjust intensity, adjust frequency, or otherwise shape and direct one or more energy beams received from the energy source 412 toward the energy patterning unit 416. In one embodiment, multiple light beams, each having a distinct light wavelength, can be combined using wavelength selective mirrors (e.g. dichroics) or diffractive elements. In other embodiments, multiple beams can be homogenized or combined using multifaceted mirrors, microlenses, and refractive or diffractive optical elements.

Energy patterning unit 416 can include static or dynamic energy patterning elements. For example, laser beams can be blocked by masks with fixed or movable elements. To increase flexibility and ease of image patterning, pixel addressable masking, image generation, or transmission can be used. In some embodiments, the energy patterning unit includes addressable light valves, alone or in conjunction with other patterning mechanisms to provide patterning. The light valves can be transmissive, reflective, or use a combination of transmissive and reflective elements. Patterns can be dynamically modified using electrical or optical addressing. In one embodiment, a transmissive optically addressed light valve acts to rotate polarization of light passing through the valve, with optically addressed pixels forming patterns defined by a light projection source. In another embodiment, a reflective optically addressed light valve includes a write beam for modifying polarization of a read beam. In yet another embodiment, an electron patterning device receives an address pattern from an electrical or photon stimulation source and generates a patterned emission of electrons.

Rejected energy handling unit 418 is used to disperse, redirect, or utilize energy not patterned and passed through the energy pattern image relay 420. In one embodiment, the rejected energy handling unit 418 can include passive or active cooling elements that remove heat from the energy patterning unit 416. In other embodiments, the rejected energy handling unit can include a “beam dump” to absorb and convert to heat any beam energy not used in defining the energy pattern. In still other embodiments, rejected beam energy can be recycled using beam shaping optics 414. Alternatively, or in addition, rejected beam energy can be directed to the article processing unit 440 for heating or further patterning. In certain embodiments, rejected beam energy can be directed to additional energy patterning systems or article processing units.

Image relay 420 receives a patterned image (typically two-dimensional) from the energy patterning unit 416 and guides it toward the article processing unit 440. In a manner similar to beam shaping optics 414, the image relay 420 can include optics to combine, focus, diverge, reflect, refract, adjust intensity, adjust frequency, or otherwise shape and direct the patterned image.

Article processing unit 440 can include a walled chamber 448 and bed 444, and a material dispenser 442 for distributing material. The material dispenser 442 can distribute, remove, mix, provide gradations or changes in material type or particle size, or adjust layer thickness of material. The material can include metal, ceramic, glass, polymeric powders, other melt-able material capable of undergoing a thermally induced phase change from solid to liquid and back again, or combinations thereof. The material can further include composites of meltable material and non-meltable material where either or both components can be selectively targeted by the imaging relay system to melt the component that is meltable, while either leaving along the non-meltable material or causing it to undergo a vaporizing, destroying, combusting or otherwise destructive process. In certain embodiments, slurries, sprays, coatings, wires, strips, or sheets of materials can be used. Unwanted material can be removed for disposal or recycling by use of blowers, vacuum systems, sweeping, vibrating, shaking, tipping, or inversion of the bed 446.

In addition to material handling components, the article processing unit 440 can include components for holding and supporting 3D structures, mechanisms for heating or cooling the chamber, auxiliary or supporting optics, and sensors and control mechanisms for monitoring or adjusting material or environmental conditions. The article processing unit can, in whole or in part, support a vacuum or inert gas atmosphere to reduce unwanted chemical interactions as well as to mitigate the risks of fire or explosion (especially with reactive metals).

Control processor 450 can be connected to control any components of additive manufacturing system 400. The control processor 450 can be connected to variety of sensors, actuators, heating or cooling systems, monitors, and controllers to coordinate operation. A wide range of sensors, including imagers, light intensity monitors, thermal, pressure, or gas sensors can be used to provide information used in control or monitoring. The control processor can be a single central controller, or alternatively, can include one or more independent control systems. The control processor 450 is provided with an interface to allow input of manufacturing instructions. Use of a wide range of sensors allows various feedback control mechanisms that improve quality, manufacturing throughput, and energy efficiency.

In some embodiments, an additive manufacturing system can support a “switchyard” style optical system suitable for reducing the light wasted in the additive manufacturing system as caused by rejection of unwanted light due to the pattern to be printed. A “switchyard”, as used in this context, describes a system and method to redirect a complex pattern from its generation (in this case, a plane whereupon a spatial pattern is imparted to structured or unstructured beam) to its delivery through a series of switch points. Each switch point can optionally modify the spatial profile of the incident beam. The switchyard optical system may be utilized in, for example and not limited to, laser-based additive manufacturing techniques where a mask is applied to the light. Advantageously, in various embodiments in accordance with the present disclosure, the thrown-away energy may be recycled in either a homogenized form or as a patterned light that is used to maintain high power efficiency or high throughput rates. Moreover, the thrown-away energy can be recycled and reused to increase intensity to print more difficult materials. By recycling and re-using rejected light, system intensity can be increased proportional to the fraction of light rejected. This allows for all the energy to be used to maintain high printing rates. Additionally, the recycling of the light potentially enables a “bar” print where a single bar sweeps across the build platform. Alternatively, pattern recycling could allow creation of a solid-state matrix coextensive with the build platform that does not require movement to print all areas of the build platform.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. A system for providing a uniform laser beam, the system comprising:
a seed laser projecting a laser beam having a first laser beam shape;
at least one pre-amplifier positioned to receive the laser beam and amplify laser beam power to output an amplified laser beam;
a homogenizer positioned to receive the amplified laser beam from the at least one pre-amplifier and alter the first laser beam shape into a second laser beam shape; and
a main amplifier positioned to receive the amplified laser beam having the second laser beam shape from the homogenizer and further amplify laser beam power to output a further amplified laser beam.

2. The system of claim 1, wherein the further amplified laser beam from the main amplifier is directed toward a target in a two-dimensional additive manufacturing system.

3. The system of claim 1, further comprising a patterning device positioned between the homogenizer and the main amplifier.

4. The system of claim 1, wherein the main amplifier is a slab amplifier.

5. The system of claim 1, wherein the main amplifier is a non-cylindrical shaped rod.

6. The system of claim 1, wherein the main amplifier has interface plate adapting a non-cylindrical shaped rod to a standard o-ring interface.

7. A system for providing a uniform laser beam, the system comprising:
a pre-amplifier a positioned to receive the laser beam and amplify laser beam power to output an amplified laser beam;
a non-cylindrical homogenizer positioned to receive the amplified laser beam from the pre-amplifier and alter the first laser beam shape into a second laser beam shape; and
a main amplifier having a non-cylindrical cross section that is positioned to receive the amplified laser beam having the second laser beam shape from the homogenizer and amplify laser beam power to output a further amplified laser beam.

8. The system of claim 7, wherein the further amplified laser beam from the main amplifier is directed toward a target in a two-dimensional additive manufacturing system.

9. The system of claim 7, further comprising a patterning device positioned between the homogenizer and the main amplifier.

10. The system of claim 7, wherein the main amplifier has a square shaped cross section.

11. The system of claim 7, wherein the main amplifier is a non-cylindrical shaped rod attached to cylindrical end caps.

12. The system of claim 7, wherein the main amplifier has interface plate adapting a non-cylindrical shaped rod to a standard o-ring interface.

13. A laser amplifier system comprising:
a main amplifier rod having a non-cylindrical cross section; and
an interface plate surrounding and in contact with the main amplifier rod to create a cylindrical o-ring interface.

14. The system of claim 13, wherein an amplified laser beam from the main amplifier is directable toward a target in a two-dimensional additive manufacturing system.

15. The system of claim 13, further comprising a pre-amplifier a positioned to receive a laser beam and amplify laser beam power to output an amplified laser beam; and
a non-cylindrical homogenizer positioned to receive the amplified laser beam from the pre-amplifier and alter the first laser beam shape into a second laser beam shape matching the non-cylindrical cross section of the main amplifier rod.

16. The system of claim 13, wherein the main amplifier has a square shaped cross section.

17. The system of claim 13, wherein the main amplifier is a multipass amplifier.

18. The system of claim 13, further comprising a patterning device positioned to relay a laser beam toward the main amplifier rod.

19. The system of claim 13, wherein the interface plate is attached to the main amplifier with at least one of optical cement, silicone sealant, fluorosilicone sealant, or urethane.

20. The system of claim 13, wherein the non-cylindrical cross section of the main amplifier is square shaped.
